(19) United States
(12) Patent Application Publication
(10) Pub. No.: US 2026/0009643 A1
(43) Pub. Date: Jan. 8, 2026

(54) Laser-Based Suspended Ceiling Straightening Device

(71) Applicants: Timothy Leo Edwin Barrett, Surprise, AZ (US); Robert Keith Barrett, Sun City, AZ (US)

(72) Inventors: Timothy Leo Edwin Barrett, Surprise, AZ (US); Robert Keith Barrett, Sun City, AZ (US)

(21) Appl. No.: 18/765,251

(22) Filed: Jul. 6, 2024

(51) Int. Cl. G01C 15/00

(52) U.S. Cl. CPC G01C 15/004

(57) ABSTRACT

One embodiment of a laser-based alignment device designed for use in the installation of suspended ceiling grid systems. The device features a top bracket (10) with adjustable or interchangeable sizes to fit various widths of T-bars, the structural units used in ceiling grids. The bracket is affixed to the face of a T-bar using magnets, which simplifies attachment and removal without the need for clamping mechanisms. The device includes a housing that contains at least one laser generator, which can be fine-tuned using a thumb knob (70) to align the laser beam accurately with the T-bar. The laser emits a beam in a predetermined direction to assist in the precise alignment and installation of additional T-bars.

### CROSS-REFERENCE TO RELATED APPLICATIONS

This application claims the benefit of U.S. Provisional Application No. 63/512,624 filed on 2023 Jul. 8 by the present inventors.

### BACKGROUND

### Prior Art

The following is a tabulation of some prior art that presently appears relevant:

U.S. Patents

| Patent Number | Kind Code | Issue Date | Patentee |
|---|---|---|---|
| 8,925,211 | B2 | 2015 Jan. 6 | DuFour |
| 6,470,579 | B2 | 2002 Oct. 29 | Allen |

Laser devices for leveling and straightening are commonly used in the construction industry, including for the installation of suspended ceilings. Typically, these devices project a horizontal or vertical laser beam onto a surface or throughout a room, providing a reference for level or straightness. The laser may be fanned out to create a line, a point, or mounted on a spinning head to create a moving reference point.

Suspended ceilings generally use structural units, suspended from wires and attached to each other to create a grid-like support structure for ceiling tiles. An “L”-shaped piece of material, typically called wall angle, is attached to the wall. The structural units that make the field of suspended ceiling resemble the shape of a “T” when viewed from the side, hence they are generally referred to as “T-Bars” but can come in many shapes and sizes. They are generally made of metal and have a painted face, which is the top of the “T”. The T-bar is suspended with the face facing down and wires are attached to the top spine to suspend it from the deck. The main T-bars run the length of the room, and smaller T-bars are connected perpendicularly to create a grid, usually 4 feet by 2 feet in size.

Straightening suspended ceilings traditionally involves attaching a string line to opposite ends of a room and aligning a main T-bar against it. This process can be time-consuming as installers go back and forth from either side of the room to ensure the string line is straight and unimpeached by anything touching the line. Eye-balling the alignment is also a common method where the user looks down the edge of a T-bar and attempts to determine if the next one is straight. This can be inaccurate, resulting in poor appearance and improperly fitting tiles.

Some laser-based devices have attempted to solve this problem. For example, the laser-based device in U.S. Pat. No. 8,925,211 to DuFour (2012) uses a clip that fits over the T-bar, with a retaining device that engages a groove on the T-bar webbing to secure and align the housing to the T-bar. This makes the device tedious to remove, as the user must unfasten the retaining device, remove the bracket, and refasten it to another T-bar to determine if it is aligned. In addition, the dual function of the device to attach to wall angle and use of two lasers makes it large and difficult to maneuver and use, and as such, this device has not been widely adopted.

Another device outlined in U.S. Pat. No. 6,470,579 to Allen (2002) consists of a long, straight frame that has a series of feet that adjust the surface to level, and clamping mechanisms. It can fit a plurality of structures and can be positioned to align T-bars. Nevertheless, the device uses a series of clamps and feet for leveling in order to make it straight or level. The cumbersome nature of the device, and the difficulty in attaching and clamping and aligning it made the device far too difficult and inconvenient, and it has not become standard in the industry.

Some people have attempted to solve this problem. For example one device uses perpendicular channels creating a plus sign-shaped tool, which fits over the T-bar at cross sections to ensure all four angles are 90 degrees. However, this tool has not been widely adopted in the field due to its bulkiness and inability to account for any bowing of the T-bar, particularly common with thinner material such as 9/16 inch T-bar.

There remains a need for a device that is manageable, easy to use, accurate, and quick for straightening and aligning suspended ceilings.

### SUMMARY

The present invention provides an improved laser-based straightening device for suspended ceiling systems. Briefly described, the laser-based alignment device includes a top bracket with interchangeable or adjustable sizes to encompass the approximate width of the face of the structural units that comprise the field of a suspended ceiling system, generally referred to as “T-Bars,” but refer to all structural units that comprise the field of suspended ceilings. The device affixes to the face of the T-bar by means of one or several magnets in the valley of the top bracket. The walls of the bracket use the edge of the T-bar face to position the top bracket in a predetermined direction in relation to the T-bar. A housing of molded plastic, or other suitable materials, attached to the top bracket contains at least one laser generator, thereby positioning the laser in the same predetermined direction as the housing and top bracket in relation to the T-bar, with the intent of emitting the laser beam in the approximate direction of the T-bar. The user can adjust a thumb knob on the side of the device to fine-tune the laser to align approximately with the left edge of the T-bar, but it could also align with the center or right edge in other embodiments.

### Advantages

Several advantages are provided by this improved laser-based straightening device. When appropriately affixed to the face of the T-bar and the beam adjusted, the user can install additional T-bars straight in relation to the attached T-bar. Using magnets to affix the device to the T-bar, a bracket that is the approximate width of the T-bar, and the edge of the T-bar face to align the device in the approximate direction of the T-bar, the user does not need to tighten or clamp any mechanism to affix it to the T-bar. An installer can easily disconnect the device by pulling it off the T-bar and reattach it by placing the bracket over the face of the T-bar. This allows the user to check multiple directions and T-bars quickly and with ease.

### DRAWINGS—FIGURES

FIG. 1: Perspective view showing the front, top, and right side of the laser-based suspended ceiling straightening device.

FIG. 2: Perspective view showing the rear, top, and left of the laser-based suspended ceiling straightening device of FIG. 1.

FIG. 3: Top view of the laser-based suspended ceiling straightening device without the top bracket of FIG. 1 and FIG. 2.

FIG. 4: Sectional view of the laser-based suspended ceiling straightening device of FIG. 1 and FIG. 2, showing the division at the center of the laser holder.

FIG. 5: Sectional view showing from the right side, divided at the center of the magnet fitting of the laser-based suspended ceiling straightening device of FIG. 1 and FIG. 2.

FIG. 6: Perspective view of the front, bottom, right of the top bracket of the laser-based suspended ceiling straightening device of FIG. 1 and FIG. 2.

### DRAWINGS—REFERENCE NUMERALS

10. Top bracket
20. Magnet fitting
50. Left side bracket wall
60. Right side bracket wall
70. Thumb knob
90. Button cover
100. Left stud
110. Right stud
120. Coupling nut cavity
130. Glass rod cavity
140. Cavity for an M3 screw and square nut
150. Rod cavity
160. Button cavity
170. Glass channel
190. Battery cavity
200. Magnet cavities
210. Left stud cavity
220. Right stud cavity
230. Magnet fitting cutout
240. USB-C charging module cavity
250. Laser holder
260. Cylinder-shaped cavity
65. Right wall
66. Left wall

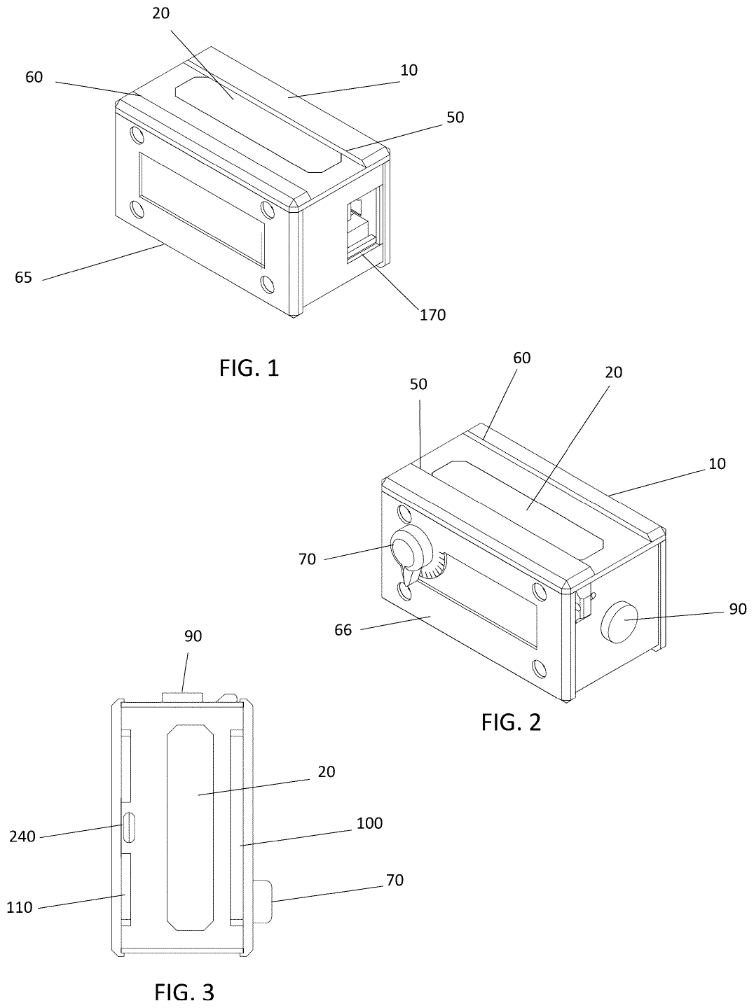

### DETAILED DESCRIPTION—FIGS. 1-6

One embodiment of the laser-based suspended ceiling straightening device comprises several components designed to facilitate the precise alignment of suspended ceiling T-bars, illustrated in FIG. 1 (perspective view of front) and FIG. 2 (perspective view of rear) The top bracket 10 is constructed from molded plastic, though it may also be fabricated from a variety of other suitable materials. The bracket features two relatively vertical walls, the left side bracket wall 50 and the right side bracket wall 60, which create a channel where the bottom is the valley, that fits the approximate width of the face of a T-bar. This channel can accommodate various standard T-bar widths, such as 9/16 inch or 15/16 inch. Positioned in the valley of the top bracket 10 is a magnet fitting 20, which secures conventional neodymium magnets housed in the top of the device (not shown) allowing for stable attachment to the T-bar. Other embodiments could use a plurality of magnets types, shapes and could be one or multiple magnets.

In FIG. 1, a perspective view shows the front, top, and right side of the laser-based suspended ceiling straightening device. The depicted device is made of molded plastic but could by made of any suitable material. The top bracket 10 is connected to the top of the device, featuring the left side bracket wall 50 and right side bracket wall 60. The magnet fitting 20 is located in the valley of the bracket, allowing the device to be affixed to the T-bar via conventional neodymium magnets (not shown). The outside of the right wall 65 is shown which is made of molded plastic but could be made of any suitable material.

In FIG. 2, a perspective view shows the rear, top, and left side of the device. The thumb knob 70 is used to adjust the direction of the laser to align it with the edge of the T-bar. A button cover 90 on the back of the device activates the laser when pressed, engaging a conventional self-locking switch button module (not shown) inside the device.

In FIG. 3, a top view of the device without the top bracket 10 is depicted which is made of molded plastic but could be made of any suitable material. The left stud 100 and right stud 110 are visible. When the top bracket 10 is fitted to the top of the device the right stud 110 fits into the right stud cavity 220 (as shown in FIG. 6) at the bottom of the top bracket 10, and the left stud 100 fitting into the left stud cavity 210 (also shown in FIG. 6) at the bottom of the top bracket 10. Additionally, the magnet fitting 20, fits through the magnet cavity 200. With the top bracket 10 properly fitted to the top of the device, the bracket is held in place by friction of the outlined fittings and studs. The right stud 110 is interrupted by a USB-C charging module cavity 240, in which a conventionally available 5V USB-C Charging Module is inserted (not shown).

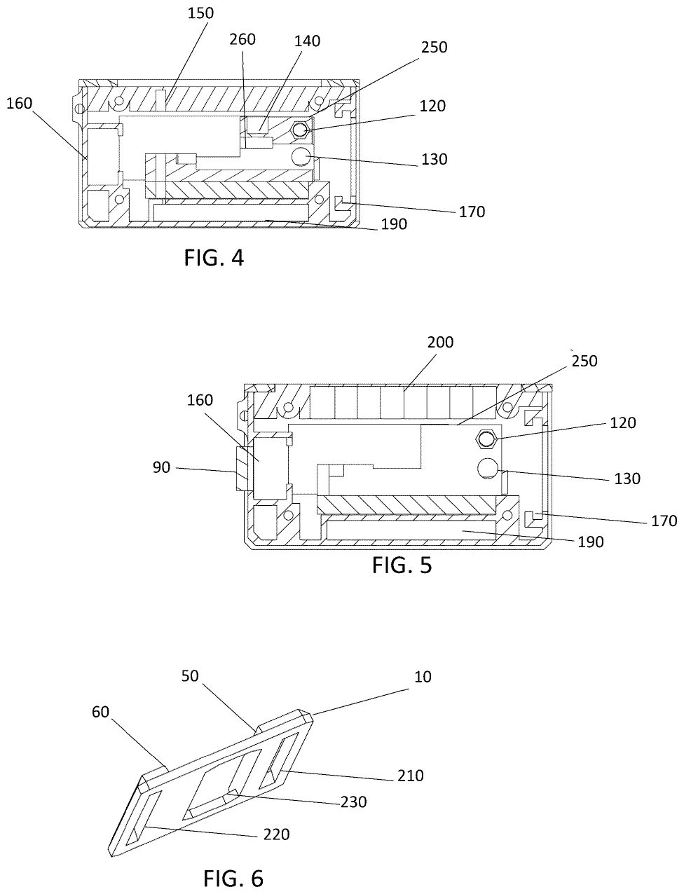

In FIG. 4, a sectional view of the device shows the laser holder 250, which is made of molded plastic but could be comprised of any suitable material. A rod cavity 150 allows a conventionally available steel rod approximately 2.6 mm in diameter (not shown) to fit through the top of the device, the laser holder 250, and the bottom of the device to secure the laser holder 250 in place. The laser holder 250 includes a cylinder-shaped cavity 260 for a conventional 7 mm in diameter green-beam laser diode (not shown). A cavity at the top of the laser holder 250 houses a conventionally available 3 mm M3 screw and square nut (not shown) that fit into the cavity for an M3 Screw and Nut 140. The 3 mm M3 screw is tightened through the square nut, applying pressure to the laser diode to hold it in place. Additionally, there is a glass rod cavity 130 in the laser holder to insert a conventional 5 mm glass rod (not shown) that spreads the beam emitted by the laser module into a an approximately vertical line. The laser holder 250 also contains a cavity for a coupling nut 120 which a conventional M3 coupling 10 mm coupling nut (not shown) is inserted. The thumb knob 70 is fitted with conventional knurled M3 screw knob approximately 13 mm in length (not shown) that engages the coupling nut. A conventional spring (not shown) applies pressure to the inside of the left wall 66 and to the laser holder 250, the laser holder pivots on the steel rod adjusting the direction of the laser holder 250 to the right, thereby adjusting the direction of the laser beam. By tightening or loosening the thumb knob 70, the user can adjust the laser holder's 250 position, thereby fine-tuning the laser beam direction. A glass channel 170 on the inner front of the device holds a conventional glass lens (not shown), allowing the laser beam to pass through and protect the inner components. The inside bottom of the device houses a battery cavity 190, in which a conventional 30 mm×90 mm×5 mm battery (not shown) is stored while the rear inside of the device features a button cavity 160 to accommodate the conventional self-locking switch button module (not shown). The battery is connected to the charging module, which is wired to the self-locking button and connected to the laser diode. Thereby users can charge the battery by means of the charging module, and turn off and on the laser diode by means of the self-locking button module.

In FIG. 5, a cross-sectional view from the right side, divided at the center of the magnet fitting 20, shows a series of magnet cavities 200 in the top of the device. The present embodiment shows multiple cavities to fit a group of conventional neodymium magnets (not shown) that are affixed by adhesive to the top inside of the device, to affix to the T-bar. However, it this cavity could fit one large magnet or more smaller magnets of a plurality of types, sizes, and shapes.

In FIG. 6, a perspective view of the front, bottom, and right side of the top bracket 10 is shown. The right stud cavity 220 and left stud cavity 210 are visible, along with the magnet fitting cut out 230, which allows the magnet fitting 20 to pass through the top bracket 10. The space between right side bracket wall 60 and left side bracket wall 50 could be any distance to fit the plurality of T-bar types and widths, including 9/16 inch, 15/16 inch, etc.

### Operation

In operation, the user places the top bracket 10 over the face of a T-bar, securing the device to the T-bar via the magnets housed in the magnet cavities 20. The left side bracket wall 50 and right side bracket wall 60 align the device with the edges of the T-bar face, ensuring the device is oriented in the approximate direction of the T-bar. The user activates the laser by pressing the button cover 90, which engages the self-locking switch button module inside the button cavity 160, emitting a laser beam through the glass rod housed in the laser holder 250 glass rod cavity 130 to spread the beam vertically. The user can then adjust the laser beam's direction by turning the thumb knob 70, which, through the coupling nut 120 and spring mechanism, adjusts the position of the laser holder 250 to fine-tune the beam alignment.

The device allows for easy attachment and removal from the T-bar due to its magnetic affixation mechanism. The top bracket 10, combined with the magnet fitting 20 and the vertical walls of the bracket, provides a secure and precise alignment tool that can be easily repositioned without the need for additional clamping mechanisms.

### Advantages

From the description above, a number of advantages of some embodiments of this device become evident:

(a) The device utilizes magnets housed in the top bracket to affix to the face of the T-bar. This magnetic attachment allows for quick and effortless placement and removal without the need for clamping mechanisms, significantly reducing setup and adjustment time.

(b) The bracket is designed with two relatively vertical walls that fit over the T-bar face. These walls use the edge of the T-bar face to align the device in the approximate direction of the T-bar, ensuring that the apparatus is aligned with the T-bar.

(c) The device features a thumb knob that allows the user to fine-tune the direction of the laser beam. This adjustability ensures that the laser can be aligned to the approximate edge of the T-bar, enhancing the precision of the alignment process.

(d) Multiple top brackets can be available to accommodate different standard T-bar widths, such as 9/16 inch or 15/16 inch. This versatility ensures that the device can be used with a wide range of T-bar sizes commonly found in suspended ceiling installations.

### CONCLUSION, RAMIFICATIONS, AND SCOPE

Accordingly, the reader will see that this laser-based suspended ceiling straightening device simplifies the process of installing ceilings, providing a quick and accurate method to align and straighten T-bars, thereby increasing the efficiency and ease of the installation process.

Although the description above contains many specificities, these should not be construed as limiting the scope of the embodiments but as merely providing illustrations of some of several embodiments. For example, the device could have multiple lasers, a cross section in the bracket to allow the device to fit over the intersect of T-bars, etc.

Thus the score of the embodiments should be determined by the appended claims and their legal equivalents, rather than by the examples given.

1. A laser-based alignment device for suspended ceiling systems, comprising:
A bracket with at least two roughly vertical walls, said bracket fitting over and being the approximate width of the face of the structural units that comprise the horizontal grid field of a suspended ceiling system;
at least one vertical wall of the bracket using the edge of the structural units face to orient at least one laser device housing in a predetermined direction in relation to the structural unit;
at least one laser generator supported by the housing, the laser generator being positioned to emit a laser beam in a predetermined direction in relation to the structural unit;
means for using magnets to affix the device to the face of the structural unit.

2. The device of claim 1, wherein the bracket includes a magnet fitting positioned in the valley of the bracket to allow magnets housed in the top of the device to affix to the structural units.

3. The device of claim 1, where the bracket is made of molded plastic.

4. The device of claim 1, where the bracket is connected to the top of the device by studs.

5. The device of claim 1, further comprising a thumb knob for adjusting the direction of the laser beam to align it with the structural units.

6. The device of claim 1, wherein the thumb knob is fitted with a screw that engages a coupling nut, allowing the user to tighten or loosen the thumb knob to adjust the direction of the laser beam.

7. The device of claim 1, wherein the laser generator includes a laser diode that emits the beam vertically.

8. The device of claim 1, wherein the bracket is detachable.

9. The device of claim 1, further comprising a USB-C charging module for recharging the device.

10. The device of claim 1, wherein the top bracket can be adjusted to accommodate different widths of structural units such as 9/16 inch or 15/16 inch.

11. The device of claim 1, wherein the top bracket can be removed and replaced to accommodate different widths of structural units such as 9/16 inch or 15/16 inch.

12. The device of claim 1, wherein the laser is projected down the edge or center of the structural unit.
